(19) United States
(12) Patent Application Publication
(10) Pub. No.: US 2019/0284039 A1
(43) Pub. Date: Sep. 19, 2019

(54) WATER DISPENSER TRACKING SYSTEM

(71) Applicant: Healthy Waterways Limited, Spring Hill, QLD (AU)

(72) Inventor: Faye LEE, New Beith, QLD (AU)

(21) Appl. No.: 16/340,287

(22) PCT Filed: Oct. 10, 2017
(86) PCT No.: PCT/AU2017/051093

§ 371 Date: Apr. 8, 2019

(30) Foreign Application Priority Data
Oct. 10, 2016 (AU) 2016904166

(51) Int. Cl. B67D 1/08

(52) U.S. Cl. CPC B67D 1/0878; B67D 1/0877

(57) ABSTRACT

A system for tracking a water dispenser location, the system including: a plurality of water dispensers, each water dispenser being adapted to dispense potable water from a potable water supply; one or more processing devices; and, a client device in communication with the one or more processing systems via a communications network, and wherein in use: the client device: generates a dispenser location request at least partially indicative of a user location; and, provides the dispenser location request to the one or more processing systems via the communications network; the one or more processing systems: receive the dispenser location request; determine a dispenser location of at least one water dispenser in a vicinity of the user location using dispenser location data stored in a data store; generate a dispenser location response indicative of the dispenser location of at least one water dispenser; and, provide the dispenser location response to the client device; and, the client device: receives the dispenser location response; and, displays an indication of the dispenser location of the at least one water dispenser using the dispenser location response.

### BACKGROUND OF THE INVENTION

The present invention relates to a system for tracking a water dispenser location.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

The world is spending $100 billion on bottled water per year, with global consumption increasing by 10% per year. However, bottled water is expensive, costing up to 1,000 times the amount of tap water. Additionally, in scientific testing, bottled water has been found to be no safer than tap water, with one in five ‘bottled water’ samples containing more bacteria than allowed under guidelines.

A further drawback of bottled water is the issue of plastic bottles, which has a significant environmental impact. This includes the production of bottled water, which is energy intensive and wastes water, for example it takes three times the amount of water to make a plastic bottle as it does to fill it. Additionally, there are disposal problems associated with plastic bottles, which contributes significantly to littering. For example, in south east Queensland, plastic bottles constitute over 22% of waterway litter.

Despite the above drawbacks, bottled water remains popular largely due to portability, availability and hence convenience. An alternative to bottled water is the use of water fountains, however these are only of limited availability, can be difficult to locate and many users have concerns regarding hygiene.

AU2014100753 describes a water dispensing system including an inlet that connects to a potable water supply, an additive supply that selectively provides at least one additive for mixing with the potable water, at least one outlet coupled to the inlet that in use dispenses at least one of potable water and enhanced water including at least one additive and a receptacle dispenser that dispenses a reusable bottle.

### SUMMARY OF THE PRESENT INVENTION

In one broad form the present invention seeks to provide a system for tracking a water dispenser location, the system including:
a) a plurality of water dispensers, each water dispenser being adapted to dispense potable water from a potable water supply;
b) one or more processing devices; and,
c) a client device in communication with the one or more processing systems via a communications network, and wherein in use:
   i) the client device:
      (1) generates a dispenser location request at least partially indicative of a user location; and,
      (2) provides the dispenser location request to the one or more processing systems via the communications network;
   ii) the one or more processing systems:
      (1) receive the dispenser location request;
      (2) determine a dispenser location of at least one water dispenser in a vicinity of the user location using dispenser location data stored in a data store;
      (3) generate a dispenser location response indicative of the dispenser location of at least one water dispenser; and,
      (4) provide the dispenser location response to the client device; and,
   iii) the client device:
      (1) receives the dispenser location response; and,
      (2) displays an indication of the dispenser location of the at least one water dispenser using the dispenser location response.

Typically the one or more processing devices:
a) determine the location of a water dispenser in accordance with at least one of:
   i) a location indication received from the water dispenser;
   ii) a location of a client device; and,
   iii) user input commands; and,
b) update the dispenser location data in accordance with the determined location.

Typically at least one of the plurality of water dispensers includes:
a) a location module adapted to determine a dispenser location;
b) a communications module; and,
c) a water dispenser processor that:
   i) determines a dispenser location from the location system; and,
   ii) causes the communications module to provide a location indication to the one or more processing systems.

Typically the water dispenser processor determines a water dispenser location at least one of:
a) periodically;
b) in response to a location query received from one or more processing devices; and,
c) upon detection of movement by the water dispenser processor, the detection of movement being determined based on at least one of:
   i) signals from a movement sensor; and,
   ii) changes in location determined by the location system.

Typically the location indication includes an indication of a water dispenser identifier, and wherein the one or more processing systems update the dispenser location data in accordance with the water dispenser identifier.

Typically the client device:
a) determines a water dispenser identifier and location; and,
b) provides a location indication to the one or more processing systems.

Typically the client device:
a) determines the water dispenser identifier at least one of:
   i) in accordance with user input commands; and,
   ii) by detecting coded data associated with the water dispenser; and,
b) determines the location in accordance with at least one of:
   i) user input commands; and,
   ii) using a client device location module adapted to the determine a client device location.

Typically the client device generates the dispenser location request in accordance with at least one of:
a) user input commands; and,
b) using a client device location module adapted to determine a client device location.

Typically the client device:
a) generates a representation of the dispenser location, the representation including:
   i) a map; and
   ii) at least one icon indicative of the dispenser location of the at least one water dispenser; and,
b) displays the representation.

Typically the dispenser location response is indicative of a dispenser identifier, and wherein the client device is responsive to the dispenser location response to display an indication of the dispenser identifier.

Typically the client device:
a) determines an operational status of the water dispenser;
b) generates a dispenser status indication at least partially indicative of the operational status; and,
c) provides the dispenser status indication to the one or more processing systems via a communications network, the one or more processing systems being responsive to the dispenser status indication to update status data stored in a data store.

Typically the dispenser status indication is indicative of a water dispenser identifier.

Typically the client device determines the operational status in accordance with at least one of:
a) user input commands; and,
b) signals from a measurement device.

Typically the dispenser status indication is indicative of at least one of:
a) a water dispenser appearance;
b) a water dispenser integrity;
c) a water quality;
d) a water purity;
e) a water dispensing rate; and,
f) a water temperature.

Typically the dispenser location response is at least one of:
a) indicative of an operational status of the water dispenser; and,
b) selectively generated depending on the operational status of the water dispenser.

Typically the water dispenser includes:
a) a housing;
b) an inlet that connects to a potable water supply; and,
c) an outlet coupled to the inlet that in use dispenses potable water.

Typically the water dispenser includes a chiller for chilling the potable water.

Typically the water dispenser is a portable water dispenser.

Typically at least one water dispenser includes a display that selectively displays advertising at least one of:
a) retrieved from a local store; and,
b) received via a communications network.

In one broad form the present invention seeks to provide a system for tracking a water dispenser location, the system including one or more processing systems that:
a) receive a dispenser location request from a client device via a communications network, the dispenser location request being at least partially indicative of a user location;
b) determine a dispenser location of at least one water dispenser in a vicinity of the user location using dispenser location data stored in a data store;
c) generate a dispenser location response indicative of the dispenser location of at least one water dispenser; and,
d) provide the dispenser location response to the client device, the client device being responsive to the dispenser location response to:
   i) receive the dispenser location response; and,
   ii) display an indication of the dispenser location of the at least one water dispenser using the dispenser location response.

In one broad form the present invention seeks to provide a system for tracking a water dispenser location, the system including at least one client device that:
a) generates a dispenser location request at least partially indicative of a user location;
b) provides the dispenser location request to the one or more processing systems via a communications network, the one or more processing systems being responsive to the dispenser location request to:
   i) receive the dispenser location request;
   ii) determine a dispenser location of at least one water dispenser in a vicinity of the user location using the dispenser location data stored in a data store;
   iii) generate a dispenser location response indicative of the dispenser location of at least one water dispenser; and,
   iv) provide the dispenser location response to the client device;
c) receives the dispenser location response; and,
d) displays an indication of the dispenser location of the at least one water dispenser using the dispenser location response.

In one broad form the present invention seeks to provide a system for tracking a water dispenser location, the system including at least one water dispenser including:
a) a housing;
b) an inlet that connects to a potable water supply;
c) an outlet coupled to the inlet that in use dispenses potable water;
d) a location system adapted to the determine a dispenser location;
e) a communications module; and,
f) a water dispenser processor that:
   i) determines a dispenser location from the location system; and,
   ii) causes the communications module to provide a location indication to the processing device.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which: —

FIG. 1 is a schematic diagram of an example of a system for tracking a water dispenser location;

FIG. 2 is a flowchart of an example of a process for tracking a water dispenser location;

FIG. 3 is a schematic diagram of an example of a processing system;

FIG. 4 is a schematic diagram of an example of a client device;

FIG. 5 is a schematic diagram of a first example of a water dispenser;

FIG. 6 is a schematic diagram of a second example of a water drink dispensing system;

FIG. 7 is a schematic diagram of an example of an external housing of a further example of a water dispenser;

FIG. 8 is a schematic diagram of the functionality of the water dispenser of FIG. 7;

FIGS. 9A and 9B are a flowchart of a specific example of a system for tracking a water dispenser location;

FIG. 10 is a flowchart of an example of a process for updating a water dispenser location;

FIG. 11 is a flowchart of second example of a process for updating a water dispenser location; and,

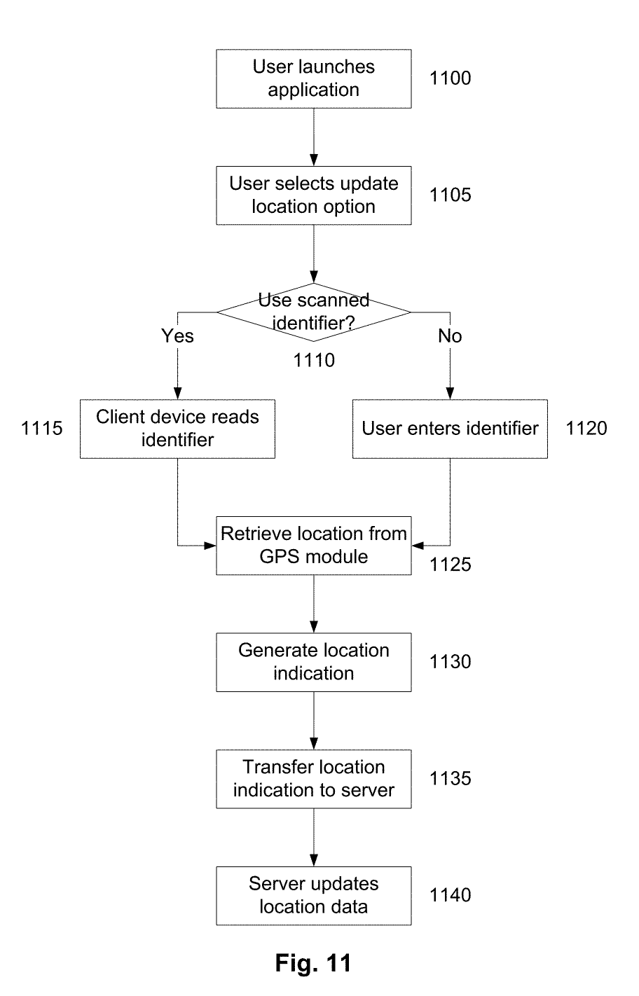

FIG. 12 is a flowchart of an example of a process for monitoring an operational status of a water dispenser.

### DETAILED DESCRIPTION OF THE PREFERRED EMBODIMENTS

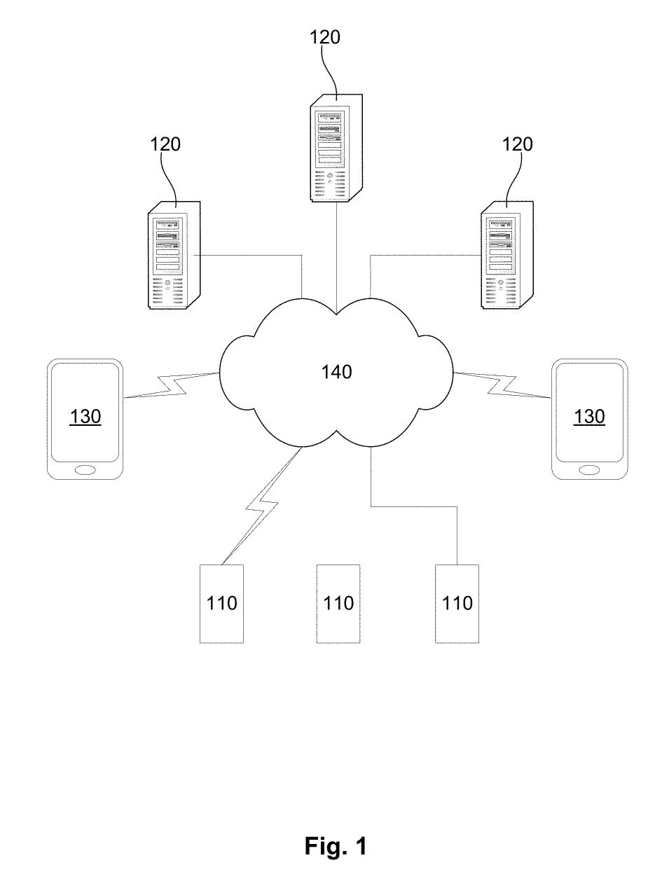

An example of a system for tracking water dispenser will now be described with reference to FIG. 1.

In this example, the system includes a plurality of water dispensers 110. Each water dispenser is typically adapted to dispense potable water from a potable water supply. The water dispensers can be permanent in situ water dispensers, but more typically also include at least one portable water dispenser. Whilst three water dispensers are shown, this is for the purpose of illustration only and is not intended to be limiting.

The system also typically includes one or more processing devices 120 and one or more client devices 130 that are interconnected via a communications network 140, such as the Internet, or a number of local area networks (LANs) or the like. Any number of processing systems 120 and client devices 130 could be provided and the current representation is for the purpose of illustration only. The configuration of the networks 140 is also for the purpose of example only, and in practice, the processing systems 120 and the client devices 130 can communication via any appropriate mechanism, such as via wired or wireless connections, including but not limited to mobile networks, private networks, such as an 802.11 network, the internet, LANs, WANs or the like, as well as by direct or point to point connections, such as Bluetooth or the like.

Additionally, as shown, one or more of the water dispensers 110 may be interconnected to the communications network via wired or wireless connections, as will be described in more detail below.

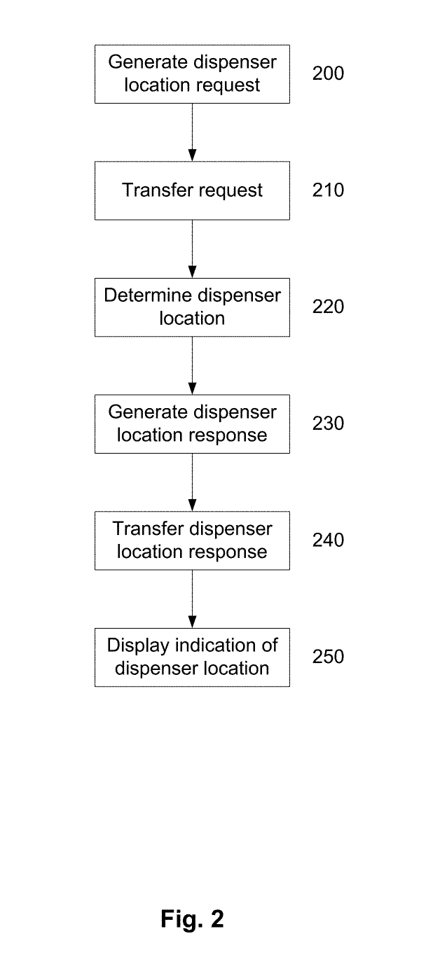

An example of a process for tracking a dispenser location will now be described with reference to FIG. 2.

In this example, at step 200, a client device 130 is used to generate a dispenser location request. The dispenser location request is typically at least partially indicative of a user location, such as a current location of the client device 130, or a location identified by the user, such as a location of interest to the user. The location request could be of any appropriate form and may be in the form of a system message, http (Hypertext Transfer Protocol) request or the like.

The dispenser location request is transferred to one of the processing systems 120 at step 210, for example by having the client device provide the location request via the communications network, with the processing system 120 operating to receive the provided dispenser location request.

At step 220, the processing system 120 determines a dispenser location of at least one water dispenser that is in a vicinity of the user location using dispenser location data, which is stored in a data store. The dispenser location data is indicative of the location of each of a plurality of water dispensers and can be created in any one of a number of ways, such as by defining this when a static water dispenser is installed, or by basing this on location information provided by a water dispenser in use. The process of determining the dispenser location typically involves querying the dispenser location data based on the user location, in order to return dispenser locations of one or more water dispensers within a defined distance of the user location.

At step 230, the one or more processing systems 120 generate a dispenser location response indicative of the dispenser location, transferring this to the client device 130 at step 240. Thus, this could be achieved by generating a system message, webpage or the like, which includes information regarding the dispenser location. The dispenser location response is then provided by the processing system 120 to the client device, which receives the response, allowing the client device 130 to display an indication of the dispenser location at step 250.

Thus, for example, the dispenser location response could include a simple list of dispenser locations, which are then displayed to the user, or alternatively, could include a representation of a map, showing the location of the water dispensers, which is displayed to the user. Alternatively, the dispenser location response could simply include a list of locations, with these then being used to generate a map internally within the client device 130, for example using a mapping application, or the like, with the location of water dispensers displayed thereon.

In any event, it will be appreciated that the above described systems allows the location of water dispensers to be determined and then displayed to users. This is important, as it allows users to readily identify the location of water dispensers, enabling ready access to potable water, and reducing the requirement for purchasing of bottled water or the like. Furthermore, as at least some of the water dispensers may be portable, this allows the system to be used to locate the water dispensers if these are moved by third parties as well as reducing incidences of theft or the like.

A number of further features will now be described.

The location of the water dispensers can be determined in any one of a number of ways depending on the preferred implementation and the particular circumstances. For example, the location of a water dispenser can be determined in accordance with a location indication received from the water dispenser itself, a location of a client device, for example when positioned in the vicinity of a water dispenser, or based on user input commands. Irrespective of how this is achieved, when the location is provided to the one or more processing devices 130, these then operate to update the dispenser location data stored in the store. Whilst this process could be performed a single time upon installation of a water dispenser, more typically the information is updated periodically in order to ensure the dispenser location data reflects the current water dispenser location.

The location indication can include an indication of a water dispenser identifier, such as a unique alphanumeric code or similar, with the one or more processing systems 120 updating the dispenser location in accordance with the water dispenser identifier. This is performed so that the location of any particular water dispenser can be tracked, which can facilitate maintenance, repairs and ensuring that all water dispensers are correctly accounted for.

In order for the location indication to be received from the water dispenser, the water dispenser must include inbuilt electronics allowing the location to be determined. In one example, this is achieved by having the water dispenser include a location module adapted to determine a dispenser location, such as a GPS module, or the like. The water dispenser also includes a communications module, such as a GPRS module, and a water dispenser processor that determines a dispenser location from the location system and causes the communications module to provide a location indication to the one or more processing systems.

In this example, the water dispenser processor can determine the water dispenser location periodically, such as once a day, or in response to a location query received from the one or more processing devices 120. Thus, for example, the processing devices 120 may query the water dispenser processor and receive a response including the dispenser location. A further alternative is for the water dispenser to provide an indication of dispenser location upon detection of movement. This can be achieved either based on signals from a movement sensor or based in changes in location determined by the location system.

In one example, a water dispenser location could be tracked using a client device. In this case, the client device determines the water dispenser identifier and location of the water dispenser, and then uses this information to provide a location indication to the one or more processing systems. The water dispenser identifier could be determined in a variety of ways, such as by having a user enter the water dispenser identifier into the client device, or by having the client device detect coded data associated with or displayed on the water dispenser. This could include for example having a printed identifier such as a barcode, QR code or the like displayed on the water dispenser, or could involve having a detectable identifier such as an RFID tag, Bluetooth tag, or the like, coupled to the water dispenser, allowing this to be detected by the client device 130. Similarly, the location can be based on a user input location determined from user input commands, or by having the client device 130 utilise an internal location system such as a GPS module, adapted to determine the client device location.

The client device typically generates the dispenser location request in accordance with user input commands and/or a client device location determined from a location module, such as a GPS module, adapted to determine the location of the client device. Thus, the user location could be based on the current location of the client device, or could be based on a location entered manually by the user, for example allowing the user to determine if water dispensers are provided at locations other than their current location.

In terms of displaying an indication of the dispenser location, the client device can simply display an indication of the dispenser location response, which may include a map or other similar graphic. Alternatively, the client device can determine a location from the dispenser location response and then generate a representation of the dispenser location, the representation including a map and an icon indicative of the dispenser location and then display the representation to the user. Accordingly, it will be appreciated that this provides mechanisms to allow graphical display of locations, which can be more intuitive for users when attempting to find a water dispenser. However, this also allows particular display formats to be configured by a user and implemented using their client device, for example, allowing the user to display the locations in a selected mapping application or the like.

In addition to providing functionality in order to allow the location of water dispensers to be tracked, the system can also be utilised in order to provide assistance in monitoring an operational status of the water dispensers, for example to ensure they are functioning correctly, and to allow for ongoing maintenance or repair. In this regard, in one example, the client device can be operated by an individual or other entity assigned the task of monitoring and/or maintaining the water dispensers. Alternatively, this functionality could be provided to members of the public allowing monitoring to be effectively crowd sourced.

Irrespective of who is responsible for monitoring the water dispensers, this is typically achieved using a client device that operates to determine an operational status of the water dispenser, generate a dispenser status indication at least partially indicative of the operational status and provide the dispenser status indication to the one or more processing systems 120 via the communications network 140. This allows the processing systems to update status data stored in a data store, which may be stored separately to, or alternatively in conjunction with, the dispenser location data. The dispenser status indication is also typically indicative of a water dispenser identifier, allowing the dispenser operational status to be associated with a specific water dispenser. This allows per device information to be stored over time, for example allowing a profile of each water dispenser to be established that includes a current location, information regarding previous locations, as well as current and previous operational status information. This in turn allows analytics to be used to monitor operation and maintenance, for example to identify locations where water dispensers are more frequently used or more frequently require maintenance.

The client device can determine the operational status in a number of ways, such as in accordance with user input commands and/or based on signals from a measuring device. This allows the dispenser status to be indicative of a wide range of different types of information, such as water dispenser appearance, water dispenser integrity, water quality, water purity, water dispensing rate and water temperature. Thus, it will appreciated from this that monitoring personnel can perform any one of a wide number of checks regarding the operational status and then upload such information to the processing systems 120. This information can then be used to schedule maintenance or repair, as well as for ongoing logging purposes, for example to demonstrate the availability of water dispensers over time, determine cleaning or maintenance requirements, or the like.

It will be appreciated that when a dispenser location response is provided this can be indicative of an operational status of the water dispenser or could be selectively generated depending on the operational status of the water dispenser, for example to omit the location of dispensers which are not currently operational. This reduces the chance of a user being directed to a water dispenser that isn't currently operational.

The water dispensers can be of any appropriate form, but in one example include a housing, an inlet that connects to a potable water supply and an outlet coupled to the inlet that dispenses potable water in use. The water dispenser may also include a chiller for chilling the potable water. The water dispenser can be portable or alternatively may be a static device. In a further example, the water dispenser may include a display that selectively displays advertising at least one of retrieved from a local store or received via a communications network. Any combination of these features can be provided, depending on the preferred implementation and examples will be described in more detail below.

As previously mentioned, the process is performed using a system including a number of processing systems 120 coupled to one or more client devices 130, via one or more communications networks 140, such as the Internet, and/or a number of local area networks (LANs).

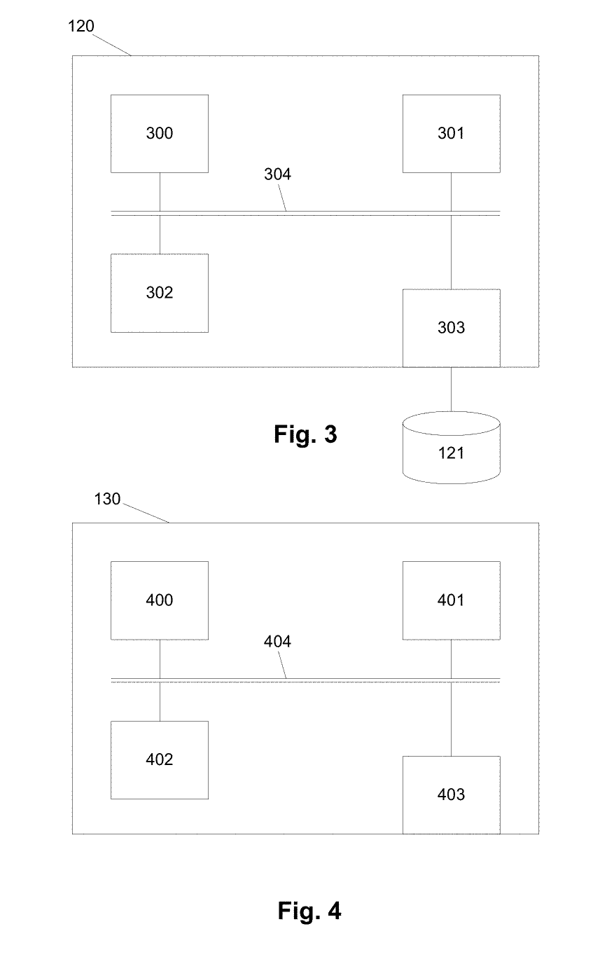

An example of a suitable processing system 120 is shown in FIG. 3. In this example, the processing system 120 includes at least one microprocessor 300, a memory 301, an optional input/output device 302, such as a keyboard and/or display, and an external interface 303, interconnected via a bus 304 as shown. In this example the external interface 303 can be utilised for connecting the processing system 120 to peripheral devices, such as the communications networks 140, databases 121, other storage devices, or the like. Although a single external interface 303 is shown, this is for the purpose of example only, and in practice multiple interfaces using various methods (eg. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 120 may be formed from any suitable processing system, such as a suitably programmed PC, web server, network server, or the like. In one particular example, the processing system 120 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

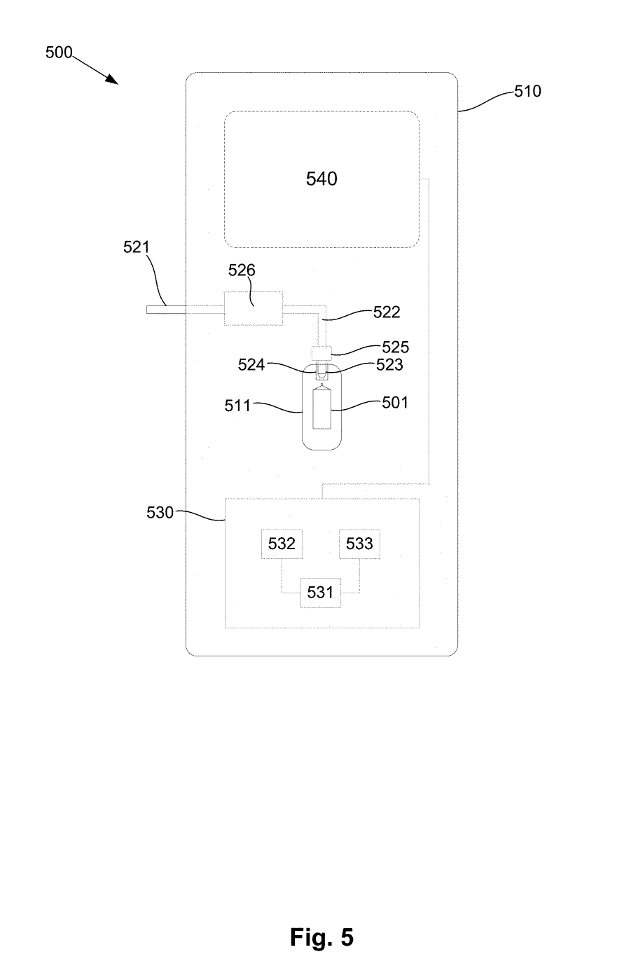

As shown in FIG. 4, in one example, the client device 130 includes at least one microprocessor 400, a memory 401, an input/output device 402, such as a keyboard and/or display, an external interface 403, and, interconnected via a bus 404 as shown. In this example the external interface 403 can be utilised for connecting the client device 130 to peripheral devices, such as the communications networks, databases, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401, and to allow communication with one of the processing systems 120.

Accordingly, it will be appreciated that the client device 130 be formed from any suitably programmed processing system and could include suitably programmed PCs, Internet terminal, lap-top, or hand-held PC, a tablet, a smart phone, or the like. However, it will also be understood that the client device 130 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for tracking water dispensers will be described in further detail below. For the purpose of these examples it is assumed that one or more respective processing systems 120 are servers and will hereinafter be referred to as servers 120. In one example, the servers 120 could host services that are accessed by the client devices 130 allowing the tracking to be performed, although alternatively this could be performed by the client device 130. The servers 120 typically execute processing device software, allowing relevant actions to be performed, with actions performed by the server 120 being performed by the processor 300 in accordance with instructions stored as applications software in the memory 301 and/or input commands received from a user via the I/O device 302. It will also be assumed that actions performed by the client devices 130, are performed by the processor 400 in accordance with instructions stored as applications software in the memory 401 and/or input commands received from a user via the I/O device 402.

However, it will be appreciated that the above described configuration assumed for the purpose of the following examples is not essential, and numerous other configurations may be used. It will also be appreciated that the partitioning of functionality between the different processing systems may vary, depending on the particular implementation.

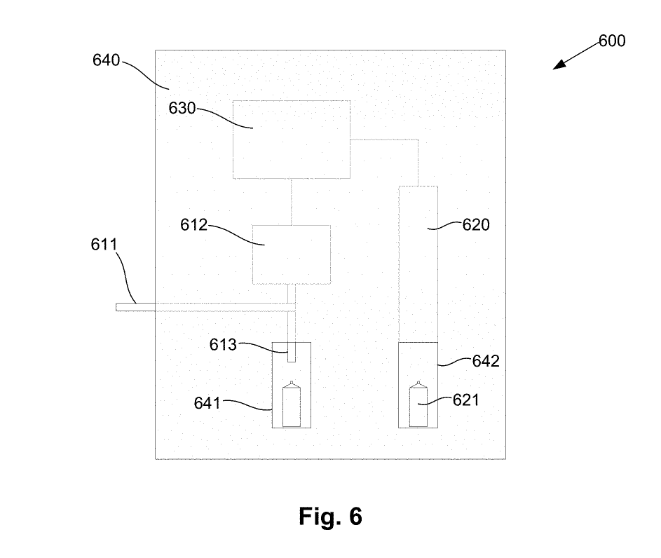

A first specific example of a water dispenser will now be described with reference to FIG. 5.

In this example, the water dispenser 500 includes a housing 510 having an opening 511. A water inlet 521 is coupled via a water conduit, such as a pipe 522 to an outlet 523, such as a dispensing nozzle. An actuator 524, such as a push lever, is typically coupled to a control valve 525, allowing potable water to be dispensed from the outlet 523 upon activation of the actuator 524. The water is typically dispensed into a suitable receptacle such as a bottle 501 or the like, provided within the opening 511. The water supply may also further include a chiller 526 adapted to chill water as it is supplied by the pipe 522 to the outlet 523.

In this example, the water dispenser 500 also includes a control system 530 having a processor 531 coupled to a location module 532, such as a GPS module, and communications module 533, such as a GPRS module, allowing the water dispenser to determine a location and communicate with the processing systems 120.

In use, the processor 531 typically operates by executing instructions in the form of applications software stored in a memory (not shown). Accordingly, it will be appreciated that the processor could be any form of electronic processing device such as a microprocessor, microchip processor, logic gate configuration, firmware optionally associated with implementing logic such as an FPGA (Field Programmable Gate Array), or any other electronic device, system or arrangement.

The controller 530 may also be coupled to a display screen 540 provided in the housing 510 allowing advertising, informative information, or the like to be displayed thereon.

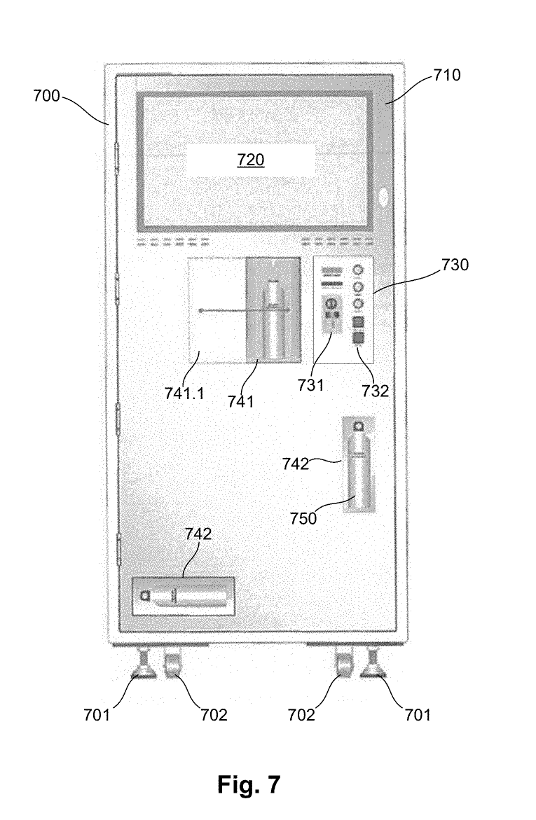

Further examples of a water dispenser also capable of dispensing other drinks will now be described with reference to FIGS. 6 to 8.

In the example of FIG. 6, the water dispensing system 600 includes an inlet 611 that connects to a potable water supply, such as a mains water supply, an additive supply 612 that selectively provides at least one additive for mixing with the potable water and at least one outlet 613, that in use dispenses at least one of potable water and enhanced water including at least one additive.

The dispensing system also includes a receptacle dispenser 620 that dispenses a reusable bottle 621. The bottle can be of any suitable form, but in one example includes a polyethylene, impact resistant, pliable bottle, such as a sports water bottle, including a removable lid, although other arrangements can be used.

The provision of a re-usable bottle allows the users to fill the bottle with potable tap water, and then carry this with them, allowing this to be consumed as required. As water is retained in a bottle, this addresses many of the hygiene concerns individuals have with water fountains, whilst also providing a convenient mechanism for consumers to avail themselves of tap water. By making the bottles re-usable this reduces the issues associated with bottled water, in particular by encouraging users to re-use the bottle as opposed to disposing of it.

To further increase the chance of bottle re-use, users can be charged for the bottles. This creates an association of value with the bottle in the mind of the user, thereby encouraging the user to re-use the bottle on subsequent occasions.

Additionally, enhanced water including additives for providing nutrients and/or flavouring can also be provided. This can assist in increasing the user base of the dispensing system, encouraging users that would normally purchase flavoured “soft” or “fizzy” drinks to also use the machine. Furthermore, by careful selection of the additives, this can present a healthier option to “soft” or “fizzy” drinks. Enhanced water can be made available for purchase, whilst ordinary tap water is made available free of charge.

It will be appreciated that in one example, tap water is therefore made available without charge, whilst bottles and enhanced water are sold as a means of subsidising the cost of manufacturing, installing and operating the drink dispenser.

A number of further features will now be described.

In one example, the dispensing system is provided in a housing 640, including openings 641, 642 to access the outlet 613 and dispensed bottles 621. Although separate openings are shown, this is not essential and alternatively a common opening could be provided.

The dispensing system can include a user input device, allowing the user to select to dispense a drink and/or bottle, a payment mechanism that receives payment from a user and a controller 630. The input device and payment device could be of any suitable form. For example, the input device could include individual buttons to order respective drinks and/or a bottle, or could include a keypad, touch screen or the like. The payment mechanism can include any one or more of a coin or note counting mechanism, credit card reader, NFC (Near Field Communications) system for communicating with an electronic wallet or mobile phone, or remote payment processing system, for example which accepts payments via mobile phone and then confirms payment to the controller. It will be appreciated that the mechanism used will vary depending on the preferred implementation.

In use, the controller 630 can determine user inputs supplied via the user input device, detect payments received via the payment device and then control the dispensing system to thereby dispense potable water without requiring a payment or a reusable bottle or enhanced water in response to receipt of a payment.

The controller 630 can also be adapted to determine the location of the water dispenser and provide an indication of this to processing systems 120, for example through incorporation of a location module and communications module, in a manner similar to that described above.

The dispensing system 600 can include additional components to facilitate dispensing, such as a pump that pumps potable water received from the potable water supply to the outlet. This may be required in the event that the supply water pressure is poor, for example if this is insufficient for subsequent filtering steps, but otherwise may not be required.

A flow meter can be used which measures a volume of potable water to be dispensed. This can be used to dispense set amounts of water, which can be useful for example, when preparing flavoured or vitamin enhanced water drinks, to ensure the concentration of the additive is appropriate. This can also allow the amount of water dispensed to be controlled to fill one of the dispensed bottles.

A filter can be provided that filters potable water received from the potable water supply. This can be of any suitable form, but in on example includes a nano-pore filter, which can assist in ensuring water cleanliness, for example by filtering out harmful bacteria or other contaminants. This allows the dispensing system to be used in situations in which the water supply is not necessarily ideal for drinking purposes, and therefore helps allay hygiene concerns of users.

The dispensing system can include a chiller that chills water received from the potable water supply. This can be particularly beneficial in a hot environment, thereby further encouraging use of the system.

A mixing unit can be provided that selectively mixes an additive with the potable water. The requirement for a mixing unit will depend on the nature of the additive, for example on whether the additive is liquid based, such as a liquid concentrate, or solid, such as a powder. In this latter scenario, the mixing unit would typically be adapted to agitate a water and powder mix to ensure the powder dissolves completely, whereas for liquid concentrates, this may not be required.

The dispensing system can include a flow control valve to selectively restrict flow of water from the outlet. This can be in the form of a solenoid flow control valve, or the like, allowing dispensing of water to be easily controlled, although any suitable technique can be used.

The additive supply can be of any suitable form, but in one example includes a plurality of additive stores, such as respective reservoirs, that store respective additives and a dosing system that selectively provides a respective quantity of at least one additive for mixing with a predetermined quantity of potable water to form the enhanced water. This allows a combination of different additives to be added to the water in a controlled manner, allowing a range of different enhanced water drinks to be provided.

In one example, the dispensing system includes a display that selectively displays advertising. The advertising can be of any suitable form, such as a video and/or image sequence and may be accompanied by associated audio information. The advertising is typically either retrieved from a local store, such as an internal database, or may be received via a communications network, such as the Internet, allowing the advertising to be controlled and/or updated remotely. Additionally, and/or alternatively, static advertising can also be provided on the housing 640. The presentation of advertising can act as an additional revenue stream, which can be used for funding installation and operation of the dispensing system.

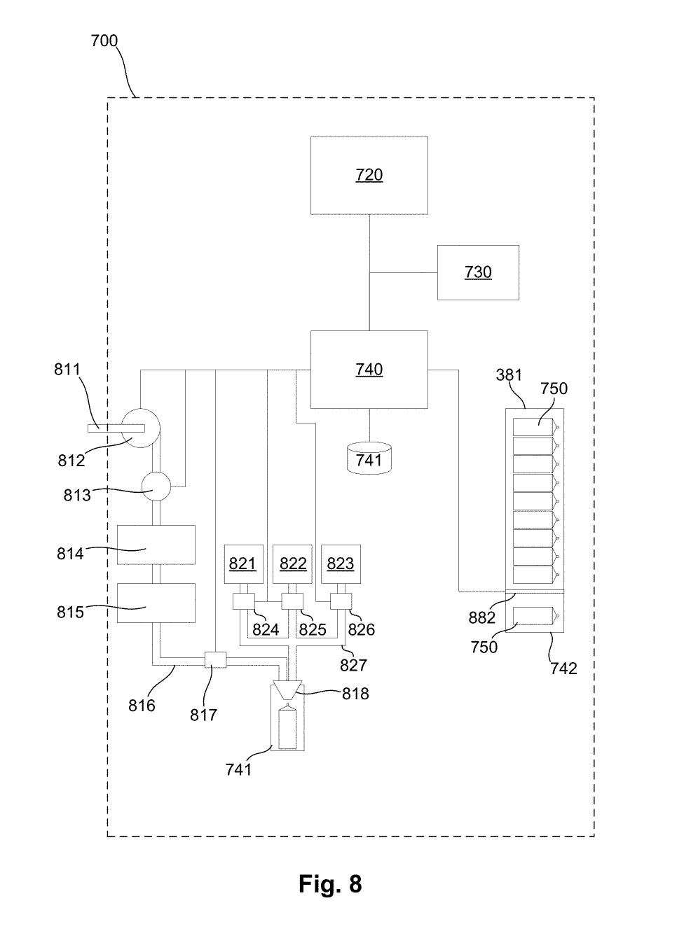

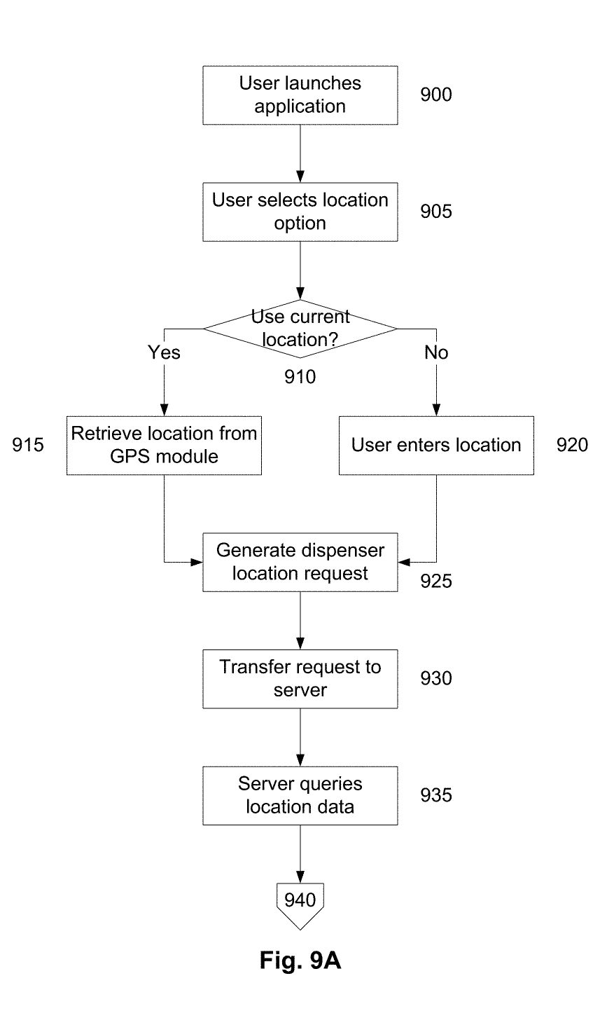

A further example dispensing system will now be described in more detail with reference to FIGS. 7 and 8.

In this example, the dispensing system includes a generally rectangular housing 700 including a door 710 in a front of the housing 700, to provide access to an internal cavity for example for re-stocking and/or maintenance purposes. The housing 700 and door 710 can be made of any suitable material, such as stainless steel, aluminium, fibreglass panels, or the like. The housing typically includes adjustable feet 701 mounted proximate a front of an underside of the housing 700 and wheels 702 mounted proximate a rear of the underside of the housing 700, thereby allowing the housing to be easily moved and installed, even on uneven surfaces.

A display screen 720 is mounted in an upper region of the door 710, thereby allowing advertising to be displayed to users during the dispensing process. It will be appreciated that in this position, the display is substantially at or near eye level, making the advertising particularly effective. However, this is not essential and a display screen 720 could be mounted elsewhere depending on the implementation.

The door 710 also includes a control panel 730 having a coin/note/credit card reader 731 and a number of input buttons 732, allowing the users to provide funds and request a drink or bottle be dispensed. It will be appreciated that this type of arrangement is similar to that of other vending machines, and will not therefore be described in any further detail.

The door 710 also includes a first opening 741, to provide access to the dispensing outlet. The first opening 741 can be covered by a sliding door 741.1 when not in use, although this is not essential. Additionally, one or more second openings 742 can be provided to allow a bottle to be dispensed. Two different openings can be provided to allow for dispensing of different bottles. For example, bottles could include empty bottles for filing with water or enhanced water, or could include pre-filled bottles. Alternatively different styles of bottle could be dispensed, allowing users to choose a style that appeals to them. A further option is for the bottles to be associated with branding or advertising, which can act as a further revenue stream. Alternatively, one of the second openings 742 could act as a display window to show an example of the bottle that will be dispensed, allowing the users to view a bottle prior to purchase, thereby assisting in making an informed decision when purchasing the bottle.

An example of the internal components of the dispensing system will now be described with reference to FIG. 8. In this example, similar reference numerals to those used in FIG. 7 are used to denote similar components.

In this example, the dispensing system includes an inlet 811, for connecting to the potable water supply, such as a mains water supply. The inlet 811 can be of any appropriate form and can include a flexible pipe, or the like, optionally including a connector, allowing this to be coupled to a tap or other suitable water supply outlet. The inlet 811 is coupled to a pump 812, such as a rotary impeller pump, which is in turn connected to a flow meter 813, filter 814 and chiller 815, via a water conduit 816. The water conduit also includes a flow control valve 817 and terminates at an outlet nozzle 818. Accordingly, in use, water received via the inlet can be pumped through the flow meter, filter and chiller, allowing filtered and chilled water to be supplied via the outlet nozzle 818. Whilst the flow control valve is shown between the chiller 815 and nozzle 818, it will be appreciated that this is not essential and the valve could alternatively be located anywhere between the inlet 811 and outlet 818.

The additive dispensing system includes three additive reservoirs 821, 822, 823 containing respective liquid concentrates, with these being connected via flow control valves 824, 825, 826 and a fluid conduit 827 to the outlet nozzle 818. In use, the flow control valves 824, 825, 826 can be used to meter out a respective amount of concentrate allowing this to be supplied to the outlet nozzle 818, for mixing with the chilled and filtered water.

The bottle dispenser includes a bottle store 381 including a number of bottles stacked above a gate 882. In use, opening of the gate allows bottles to be deposited into a cavity accessed via the opening 742, so that the user can retrieve the bottle. It will be appreciated that multiple bottle dispensers may be provided and that a single bottle dispenser is shown for the purpose of example only.

A controller 740 is provided for controlling operation of the dispensing system. The controller 740 is typically coupled to a database 741, for storing advertising and the display 720, allowing advertising to be displayed thereon. The controller 740 may also be coupled to a communications network (not shown), allowing advertising to be transferred to the dispensing system and either displayed upon receipt or alternatively stored in the database for subsequent display.

The controller 740 is also coupled to the control panel 730, allowing the controller 740 to receive signals from the coin/note/credit card reader 731 and confirm when a payment has been made, and also receive input commands via the input buttons 732, corresponding to options selected by the user. In use, the controller 740 therefore determine selections made by the user, assesses whether required payment has been made and if so can proceed with the dispensing process. As part of this, it will be appreciated that when payments are made with a credit card, the controller 740 and/or card reader may need to obtain credit card details and supply these to a payment gateway, card issuer, or the like, for validation. In this example, the controller and/or card reader would typically be connected to a communications network, such as a GSM cellular network or the like, allowing for communication with the payment gateway or other remote server, in accordance with standard credit card validation processes, as will be understood by persons skilled in the art.

The controller 740 is also coupled to the pump 812, flow control valves 817, 824, 825, 826 and the gate 882, allowing the controller 740 to generate control signals, and control these components to thereby control the dispensing processes. The controller 740 can also be coupled to the flow meter 813 allowing the controller 740 to detect signals from the flow meter and monitor the dispensing operation.

The controller 740 can also be coupled to additional sensors to sense other aspects of system operation. This can include, but is not limited to:
payment mechanism sensors to ensure correct operation of the note/coin/card reader;
tilt, vibration or access sensors to detect attempts to tamper with the housing;
temperature sensors to ensure correct operation of the chiller;
additive levels sensors to detect emptying of the additive reservoirs;
empty bottle sensors to determine if the bottle dispenser is empty.

The controller 740 can also be coupled via a communications network, such as the GSM cellular network, to a central monitoring facility, allowing the dispensing systems to be monitored remotely, and allowing intervention to be organised if required, for example for restocking and repair.

The controller 740 can also be adapted to determine the location of the water dispenser and provide an indication of this to processing systems 120, for example through incorporation of a location module and communications module, in a manner similar to that described above.

It will be appreciated from this that the controller 740 can be of any suitable form and typically includes a microprocessor, microchip processor, logic gate configuration, firmware optionally associated with implementing logic such as an FPGA (Field Programmable Gate Array), or any other electronic device, system or arrangement. The controller typically includes instructions stored in memory defining appropriate control processes for controlling dispensing of water and/or bottles.

The housing 700 would also typically include or be coupled to a power supply, allowing for power of the various components. In one example, this is achieved using a mains electricity supply, for example using a cable that connects to an external electrical supply socket, as will be appreciated by persons skilled in the art. In this example, the housing 700 would also contain any other associated required equipment, such as transformers or the like. Additionally and/or alternatively, the housing 700 could incorporate power generation equipment, such as one or more solar panels mounted to an exterior of the housing, together with associated batteries for storing the generated electricity. This can be used to allowing the dispensing apparatus to operate in absence of an external electrical supply and/or to reduce usage of external electrical supply to reduce costs associated with operating the dispensing device.

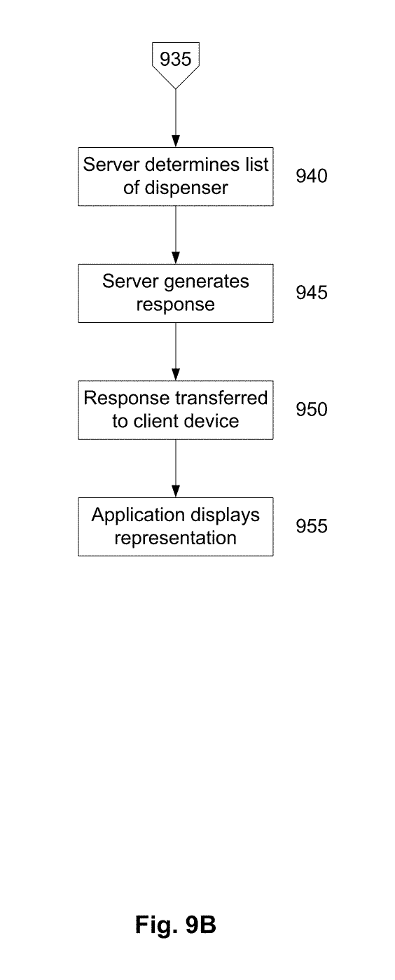

An example of the process for tracking a water dispenser will now be described with reference to FIGS. 9A and 9B.

In this example, at step 900, a user launches an application on the client device 130. The application could be an application providing specific functionality with respect to tracking of water sensors, or alternatively could be a browser application providing access to web pages hosted by the hosting servers 120. In either case, at step 905, the user selects an appropriate input option to display a location of the water dispensers.

At step 910, it is determined if a current location is to be used, for example through user input. If so, the client device 130 retrieves a location from an internal GPS module at step 915. Otherwise, the client device application displays a prompt, such as a text field, allowing a user to enter a location at step 920. It will be appreciated that this process could be interactive, for example allowing autocomplete to be used to complete an address, allowing the user to search for a location based on partial information, or the like.

Once the user location has been determined, at step 925, the client device application uses the location entered or retrieved from the GPS module to generate a dispenser location request, which is transferred to the server 120 at step 930. It will be appreciated that this process could be completed by having the user supply the user location via a webpage or similar, with completion of the relevant field corresponding to the provision of the dispenser location request.

At step 935 the server 120 queries location data stored in a database 121, retrieving details of dispensers in the vicinity of the user location at step 940. It will be appreciated that the extent of the vicinity could be predefined, or defined by the user, for example as part of the location request.

At step 945 the server 120 uses the details of the dispensers, and in particular their respective location, to generate a dispenser location response. The location could be of any appropriate form, but in one example includes GPS coordinates and/or an address, although any suitable form of location could be used. The location response can include a list of water dispenser locations, or could be in the form of a map showing locations. Depending on the usage scenario, the location response may also include other information, such as other details, operational status information, an identifier of the water dispenser, or the like.

The response is transferred to the client device at step 950, allowing a representation to be displayed at step 955. In this regard, the client device can simply display the location response, or alternatively may extract relevant information from the response and use this to display a list or map. For example, if the location response includes GPS coordinates, the client device 130 may import the GPS coordinates into a mapping application, such as Google maps, and cause a map to be displayed including an indication of the relevant locations.

It will be appreciated that the user may then interact with the representation, for example to zoom or move a point of focus. In one example, if the map is moved to an alternative location, this can cause the above described process to be repeated based on an updated user location, allowing the user to browse the map for water dispenser locations. Additionally, the manipulation could include allowing a user to select a particular water dispenser, and be provided with additional details, such as an operational status of the water dispenser, a photo showing the water dispenser and/or surrounding area, an identifier, or the like.

Accordingly, it will be appreciated that this provides a mechanism for facilitating a user in finding water dispenser locations.

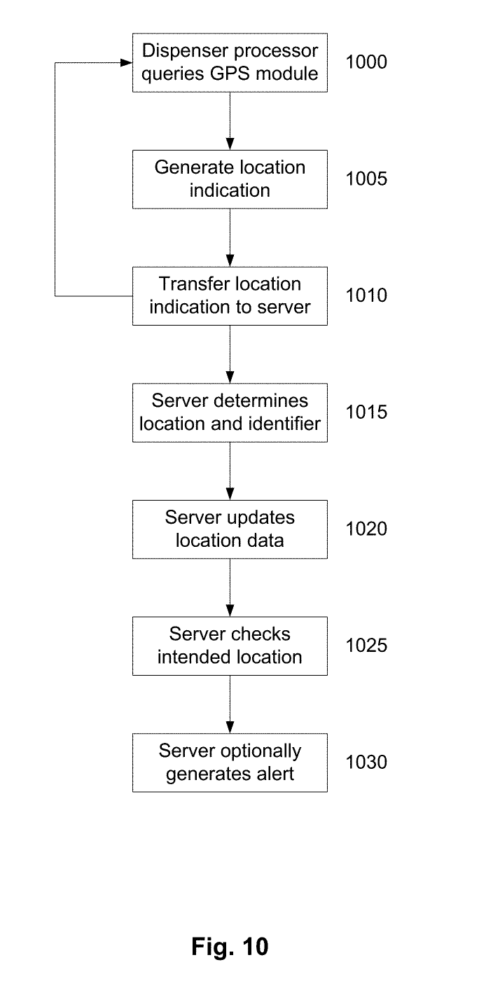

A first example of the process for updating dispenser location data will now be described with reference to FIG. 10.

In this example, at step 1000, the dispenser processor 531, queries the GPS module 532 and determines a current location. The processor generates a location indication, which could be a simple indication of the GPS coordinates, at step 1005, with this being transferred to the server 120 by the communications module 533 at step 1010. Steps 1000 to 1010 can be repeated on a periodic basis, such as hourly, daily or weekly, to ensure the current location stored by the server 120 is correct. Additionally, and/or alternatively steps 1000 to 1010 can be performed in response to a query from the server 120, or in response to detection of movement by the processor 531.

Upon receipt of a location indication, the server 120 determines a location and identifier of the water dispenser at step 1015, using this information to update the location data at step 1020.

At this stage, the server 120 may perform an optional check, for example to determine if the water dispenser is in an intended location. The intended location could be an absolute or relative location, for example defined relative to a previous location, and could be a point location or an area. The intended location is typically specified as part of the dispenser location data and can be defined upon deployment of the device and/or as required. In this instance, at step 1025, the server 120 compares the current location to the intended location, and if it is determined the water dispenser is not in the intended location an alert can be generated at step 1030, for example being provided to the client device of an individual responsible for the water dispensers. This can be used to determine if the water dispenser has been incorrectly moved from an intended location, for example to identify a potential theft or the like.

In another example, the water dispenser may not include an inbuilt location module. In this instance, the location of a water dispenser can be updated via the client device application, for example by user operating as an installer.

In this example, the user launches the application on the client device 130 at step 1100 and selects an update location option at step 1105. Again, this may be provided as part of the application, or may be part of a web page hosted by a processing system 120, and in one particular example, may be provided on a restricted version of the application or webpage, to allow only authorised individuals to update the water dispenser location.

At step 1110, it is determined whether an identifier is to be scanned or otherwise input. This determination can be made by the user, and may involve selecting an appropriate input displayed by the client device application to trigger either a reading or manual input process. If the identifier is being read, at step 1115 the client device 130 is used to read the identifier, for example by imaging a visible identifier displayed on the water dispenser, or by querying a Bluetooth or other identification tag. Otherwise, at step 1120 a prompt is displayed allowing the user to enter this information manually, for example by having the user enter an identifier number displayed on the water dispenser.

At step 1125, the client device 130 retrieves the current location from the GPS module, such as GPS coordinates, and uses this generate a location indication at step 1130. The location indication includes both the water dispenser identifier and the current client device location and is transferred to a server 120 at step 1135, allowing the server to update the stored dispenser location data at step 1140.

Accordingly, it will be appreciated that this process could be performed when installing or moving water dispensers if these are not able to monitor their own location.

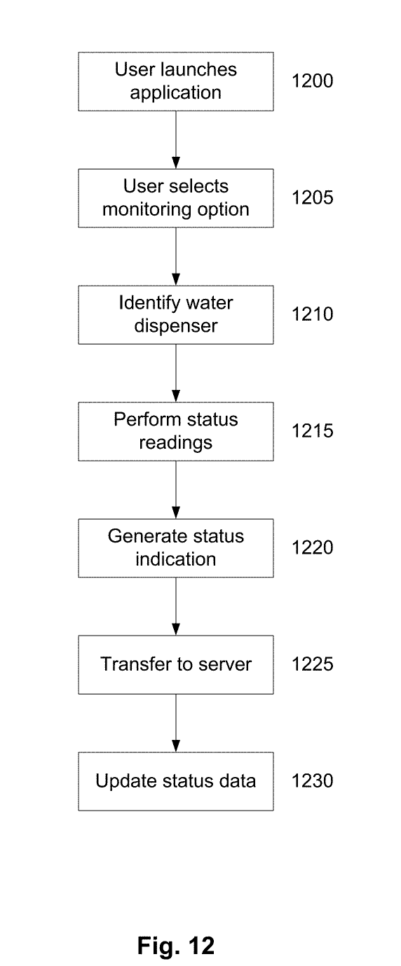

An example of the process for monitoring an operational status of water dispensers will now be described with reference to FIG. 12.

In this example, at step 1200, a user such as a person responsible for monitoring or maintaining water dispensers launches an application on their client device, and selects a monitoring option at step 1205. Again, this may be provided as part of the application, or may be part of a web page hosted by a processing system 120, and in one particular example, may be provided on a restricted version of the application or webpage, to allow only authorised individuals to monitor an operational update the water dispenser location.

At step 1210, the user is required to identify the water dispenser. This can be achieved in any one of a number of ways. For example, this could include providing an identifier of the water dispenser in a manner similar to that performed in steps 1115 or 1120 above. Alternatively, this can be achieved by retrieving the dispenser identifier based on the location of the water dispenser. In this particular instance, the client device provides a dispenser identifier request to the one or more servers 120, together with an indication of the current client device location. The server 120 uses the client device location to retrieve the water dispenser identifier from the dispenser location data stored in the data store, allowing the water dispenser identifier to be returned to the client device.

At step 1215, status readings are performed. The status readings can be performed in any one of a number of ways, and could involve manual inspection of the machine, as well as acquiring readings from sensors or other testing equipment. For example, measuring equipment could be used to measure a water temperature, water quality, water flow rate, or the like. Information regarding the operational status can then be entered into the client device application via a suitable interface, or retrieved directly by the client device, for example by having the client device 130 interact with testing equipment. Similarly photos of the water dispenser may be captured as evidence of damage, a general state of repair or appearance.

At step 1220, a status indication is generated using the information captured above, and including an indication of the water dispenser identifier. The status indication can then be transferred to the server 120 at step 1225, allowing status data to be updated at step 1230.

Accordingly, it will be appreciated that the above described system allows the location of water dispensers to be tracked and additionally allows monitoring of water dispensers to be performed in order to ensure the water dispensers are functioning correctly.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1) A system for tracking a water dispenser location, the system including:
a) a plurality of water dispensers, each water dispenser being adapted to dispense potable water from a potable water supply;
b) one or more processing devices; and,
c) a client device in communication with the one or more processing systems via a communications network, and wherein in use:
i) the client device:
(1) generates a dispenser location request at least partially indicative of a user location; and,
(2) provides the dispenser location request to the one or more processing systems via the communications network;
ii) the one or more processing systems:
(1) receive the dispenser location request;
(2) determine a dispenser location of at least one water dispenser in a vicinity of the user location using dispenser location data stored in a data store;
(3) generate a dispenser location response indicative of the dispenser location of at least one water dispenser; and,
(4) provide the dispenser location response to the client device; and,
iii) the client device:
(1) receives the dispenser location response; and,
(2) displays an indication of the dispenser location of the at least one water dispenser using the dispenser location response.

2) A system according to claim 1, wherein the one or more processing devices:
a) determine the location of a water dispenser in accordance with at least one of:
i) a location indication received from the water dispenser;
ii) a location of a client device; and,
iii) user input commands; and,
b) update the dispenser location data in accordance with the determined location.

3) A system according to claim 1, wherein at least one of the plurality of water dispensers includes:
a) a location module adapted to determine a dispenser location;
b) a communications module; and,
c) a water dispenser processor that:
i) determines a dispenser location from the location system; and,
ii) causes the communications module to provide a location indication to the one or more processing systems.

4) A system according to claim 3, wherein the water dispenser processor determines a water dispenser location at least one of:
a) periodically;
b) in response to a location query received from one or more processing devices; and,
c) upon detection of movement by the water dispenser processor, the detection of movement being determined based on at least one of:
i) signals from a movement sensor; and,
ii) changes in location determined by the location system.

5) A system according to claim 1, wherein the location indication includes an indication of a water dispenser identifier, and wherein the one or more processing systems update the dispenser location data in accordance with the water dispenser identifier.

6) A system according to claim 1, wherein the client device:
a) determines a water dispenser identifier and location; and,
b) provides a location indication to the one or more processing systems.

7) A system according to claim 6, wherein the client device:
a) determines the water dispenser identifier at least one of:
i) in accordance with user input commands; and,
ii) by detecting coded data associated with the water dispenser; and,
b) determines the location in accordance with at least one of:
i) user input commands; and,
ii) using a client device location module adapted to the determine a client device location.

8) A system according to claim 1, wherein the client device generates the dispenser location request in accordance with at least one of:
a) user input commands; and,
b) using a client device location module adapted to determine a client device location.

9) A system according to claim 1, wherein the client device:
a) generates a representation of the dispenser location, the representation including:
i) a map; and
ii) at least one icon indicative of the dispenser location of the at least one water dispenser; and,
b) displays the representation.

10) A system according to claim 1, wherein the dispenser location response is indicative of a dispenser identifier, and wherein the client device is responsive to the dispenser location response to display an indication of the dispenser identifier.

11) A system according to claim 1, wherein the client device:
a) determines an operational status of the water dispenser;
b) generates a dispenser status indication at least partially indicative of the operational status; and,
c) provides the dispenser status indication to the one or more processing systems via a communications network, the one or more processing systems being responsive to the dispenser status indication to update status data stored in a data store.

12) A system according to claim 11, wherein the dispenser status indication is indicative of a water dispenser identifier.

13) A system according to claim 11, wherein the client device determines the operational status in accordance with at least one of:
a) user input commands; and,
b) signals from a measurement device.

14) A system according to claim 11, wherein the dispenser status indication is indicative of at least one of:
a) a water dispenser appearance;
b) a water dispenser integrity;
c) a water quality;
d) a water purity;
e) a water dispensing rate; and,
f) a water temperature.

15) A system according to claim 11, wherein the dispenser location response is at least one of:
a) indicative of an operational status of the water dispenser; and,
b) selectively generated depending on the operational status of the water dispenser.

16) A system according to claim 1, wherein the water dispenser includes at least one of:
a) a housing;
b) an inlet that connects to a potable water supply;
c) an outlet coupled to the inlet that in use dispenses potable water;
d) a chiller for chilling the potable water; and,
e) a display that selectively displays advertising at least one of:
i) retrieved from a local store; and,
ii) received via a communications network.

17) (canceled)

18) A system according to claim 1, wherein the water dispenser is a portable water dispenser.

19) (canceled)

20) A system for tracking a water dispenser location, the system including one or more processing systems that:
a) receive a dispenser location request from a client device via a communications network, the dispenser location request being at least partially indicative of a user location;
b) determine a dispenser location of at least one water dispenser in a vicinity of the user location using dispenser location data stored in a data store;
c) generate a dispenser location response indicative of the dispenser location of at least one water dispenser; and,
d) provide the dispenser location response to the client device, the client device being responsive to the dispenser location response to:
i) receive the dispenser location response; and,
ii) display an indication of the dispenser location of the at least one water dispenser using the dispenser location response.

21) A system for tracking a water dispenser location, the system including at least one client device that:
a) generates a dispenser location request at least partially indicative of a user location;
b) provides the dispenser location request to the one or more processing systems via a communications network, the one or more processing systems being responsive to the dispenser location request to:
i) receive the dispenser location request;
ii) determine a dispenser location of at least one water dispenser in a vicinity of the user location using the dispenser location data stored in a data store;
iii) generates a dispenser location response indicative of the dispenser location of at least one water dispenser; and,
iv) provides the dispenser location response to the client device;
c) receives the dispenser location response; and,
d) displays an indication of the dispenser location of the at least one water dispenser using the dispenser location response.

22) A system for tracking a water dispenser location, the system including at least one water dispenser including:
a) a housing;
b) an inlet that connects to a potable water supply;
c) an outlet coupled to the inlet that in use dispenses potable water;
d) a location system adapted to the determine a dispenser location;
e) a communications module; and,
f) a water dispenser processor that:
i) determines a dispenser location from the location system; and,
ii) causes the communications module to provide a location indication to the processing device.
